(19) United States
(12) Patent Application Publication
(10) Pub. No.: US 2024/0041100 A1
(43) Pub. Date: Feb. 8, 2024

(54) AEROSOL-GENERATING ARTICLE COMPRISING A HEATING MATERIAL

(71) Applicant: Nicoventures Trading Limited, London (GB)

(72) Inventors: Jeonghwan PARK, London (GB); Daniel BRAY, London (GB); Gary FALLON, London (GB); Dean COWAN, London (GB)

(21) Appl. No.: 18/264,473

(22) PCT Filed: Feb. 8, 2022
(86) PCT No.: PCT/GB2022/050326

§ 371 Date: Aug. 7, 2023

(30) Foreign Application Priority Data
Feb. 9, 2021 (GB) 2101777.7
Jun. 18, 2021 (GB) 2108817.4

(51) Int. Cl. A24D 1/20; A24B 15/28; A24D 1/02; A24B 15/12; A24C 5/28

(52) U.S. Cl. CPC A24D 1/20; A24B 15/288; A24D 1/02; A24B 15/12; A24C 5/28

(57) ABSTRACT

An article for use with a non-combustible aerosol provision device can include a continuous rod of aerosol-generating material and a coil disposed around the rod of aerosol-generating material. The coil can include heating material that is heatable by penetration with a varying magnetic field. A wrapper can be arranged to surround the aerosol-generating material and a coil can be disposed around the wrapper. The article can include a rolled sheet having a spiral cross-section, the rolled sheet including aerosol-generating material and a mesh including heating material that is heatable by penetration with a varying magnetic field. Also, an article can include a continuous rod of aerosol-generating material and one or more bodies disposed in an axial region of the rod, the axial region extending along the longitudinal axis of the rod, wherein the one or more bodies have a circular cross-section and have a diameter in the range 0.5 mm to 5 mm, and wherein the one or more bodies include heating material that is heatable by penetration with a varying magnetic field.

### PRIORITY CLAIM

The present application is a National Phase entry of PCT Application No. PCT/GB2022/050326, filed Feb. 8, 2022, which claims priority from UK Application No. 2101777.7, filed Feb. 9, 2021 and UK Application No. 2108817.4, filed Jun. 18, 2021, each of which is hereby fully incorporated herein by reference.

### TECHNICAL FIELD

The present disclosure relates to an aerosol-generating article for use with a non combustible aerosol provision device, a method of a manufacturing an aerosol generating article, a body of aerosol-generating material and a non-combustible aerosol provision system including a non-combustible aerosol provision device and an aerosol-generating article.

### BACKGROUND

Certain tobacco industry products produce an aerosol during use, which is inhaled by a user. For example, tobacco heating devices heat an aerosol-generating material such as tobacco material to form an aerosol by heating, but not burning, the aerosol-generating material.

### SUMMARY

In accordance with some embodiments described herein, there is provided an article for use with a non-combustible aerosol provision device. The article comprises a continuous rod of aerosol-generating material and a coil disposed around the rod of aerosol-generating material. The coil comprises heating material that is heatable by penetration with a varying magnetic field.

In accordance with some embodiments described herein, there is provided an article for use with a non-combustible aerosol provision device. The article comprises aerosol generating material; a wrapper surrounding the aerosol-generating material; and a coil comprising heating material that is heatable by penetration with a varying magnetic field. The coil is disposed around the wrapper.

In accordance with some embodiments described herein, there is provided an article for use with a non-combustible aerosol provision device. The article comprises a rolled sheet having a spiral cross-section. The rolled sheet comprises aerosol-generating material and a mesh comprising heating material that is heatable by penetration with a varying magnetic field.

In accordance with some embodiments described herein, there is provided an article for use with a non-combustible aerosol provision device. The article comprises a continuous rod of aerosol-generating material, the rod having a longitudinal axis; and one or more bodies disposed in an axial region of the rod of aerosol-generating material, the axial region extending along the longitudinal axis of the rod. The one or more bodies have a circular cross-section and have a diameter in the range 0.5 mm to 5 mm. The one or more bodies comprise heating material that is heatable by penetration with a varying magnetic field.

In accordance with some embodiments described herein, there is provided a non-combustible aerosol delivery system comprising a non-combustible aerosol provision device and an article as set out above.

In accordance with some embodiments described herein, there is provided a method of manufacturing an article for use with a non-combustible aerosol provision device. The method comprises: transferring aerosol-generating material along a transfer path; inserting one or more bodies into an axial region of the aerosol-generating material, wherein the one or more bodies have a circular cross-section and have a diameter in the range 0.5 mm to 5 mm, and wherein the one or more bodies comprise heating material that is heatable by penetration with a varying magnetic field; and forming the aerosol-generating material into a continuous rod of aerosol generating material.

In accordance with some embodiments described herein, there is provided a body of aerosol-generating material for use with a non-combustible aerosol-provision device, the body comprising one or more filaments extending though the full length of the body, the one or more filaments formed of heating material that is heatable by penetration with a varying magnetic field.

In accordance with some embodiments described herein, there is provided a method of manufacturing an article for use with a non-combustible aerosol provision device. The method comprises: transferring aerosol-generating material along a transfer path; feeding one or more filaments into the aerosol-generating material, wherein the one or more filaments comprise heating material that is heatable by penetration with a varying magnetic field; and forming the aerosol-generating material into a continuous rod of aerosol generating material.

In accordance with some embodiments described herein, there is provided a method of manufacturing an article for use with a non-combustible aerosol provision device. The method comprises providing a continuous rod of aerosol-generating material; providing an elongate member, wherein the elongate member comprises heating material that is heatable by penetration with a varying magnetic field; and inserting the elongate member into a longitudinal end of the rod of aerosol generating material.

### BRIEF DESCRIPTION OF THE DRAWINGS

Embodiments of the disclosure will now be described, by way of example only, with reference to accompanying drawings, in which:

FIG. 1 is a side-on cross-sectional view of an aerosol-generating article.

FIG. 2 is a side-on cross-sectional view of an aerosol-generating article.

FIG. 3 is a schematic plan view of components used to form an aerosol-generating article.

FIG. 4 is an end-on cross-sectional view of an aerosol-generating article.

FIG. 5a is a side-on cross-sectional view of an aerosol-generating article.

FIG. 5b is a side-on cross-sectional view of an aerosol generating article.

FIG. 6 is a side-on cross-sectional view of an apparatus for use in the manufacture of an aerosol-generating article.

FIG. 7 is a flow diagram illustrating a method of manufacturing an aerosol-generating article.

FIGS. 8a, 8b and 8c show an example of a method of manufacturing an aerosol-generating article, and a body of aerosol-generating material comprising filaments of heating material.

FIGS. 9a and 9b show an example of a method of manufacturing an aerosol-generating article.

FIG. 10 is a schematic illustration of a system comprising the article shown in FIG. 1 and an aerosol provision device.

### DETAILED DESCRIPTION OF THE DRAWINGS

According to the present disclosure, a “non-combustible” aerosol provision system is a system in which a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the disclosure relates to consumables comprising aerosol-generating material and configured to be used with non-combustible aerosol provision devices. These consumables are sometimes referred to as articles throughout the disclosure.

A consumable is an article comprising or consisting of aerosol-generating material, part or all of which is intended to be consumed during use by a user. A consumable may comprise one or more other components, such as an aerosol-generating material storage area, an aerosol-generating material transfer component, an aerosol generation area, a housing, a wrapper, a mouthpiece, and/or an aerosol-modifying agent. A consumable may also comprise an aerosol generator, such as a heater, that emits heat to cause the aerosol-generating material to generate aerosol in use. The heater may, for example, comprise combustible material, a material heatable by electrical conduction, or a susceptor.

In some embodiments, the non-combustible aerosol provision system, such as a non-combustible aerosol provision device thereof, may comprise a power source and a controller. The power source may, for example, be an electric power source or an exothermic power source. In some embodiments, the exothermic power source comprises a carbon substrate which may be energized so as to distribute power in the form of heat to an aerosol-generating material or to a heat transfer material in proximity to the exothermic power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

A heating material (or susceptor) is a material that is heatable by penetration with a varying magnetic field, such as an alternating magnetic field. The susceptor may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The susceptor may be both electrically-conductive and magnetic, so that the susceptor is heatable by both heating mechanisms. The device that is configured to generate the varying magnetic field is referred to as a magnetic field generator, herein.

Induction heating is a process in which an electrically-conductive object is heated by penetrating the object with a varying magnetic field. The process is described by Faraday's law of induction and Ohm's law. An induction heater may comprise an electromagnet and a device for passing a varying electrical current, such as an alternating current, through the electromagnet. When the electromagnet and the object to be heated are suitably relatively positioned so that the resultant varying magnetic field produced by the electromagnet penetrates the object, one or more eddy currents are generated inside the object. The object has a resistance to the flow of electrical currents. Therefore, when such eddy currents are generated in the object, their flow against the electrical resistance of the object causes the object to be heated. This process is called Joule, ohmic, or resistive heating. An object that is capable of being inductively heated is known as a susceptor.

In one embodiment, the susceptor is in the form of a closed circuit. It has been found that, when the susceptor is in the form of a closed circuit, magnetic coupling between the susceptor and the electromagnet in use is enhanced, which results in greater or improved Joule heating.

Magnetic hysteresis heating is a process in which an object made of a magnetic material is heated by penetrating the object with a varying magnetic field. A magnetic material can be considered to comprise many atomic-scale magnets, or magnetic dipoles. When a magnetic field penetrates such material, the magnetic dipoles align with the magnetic field. Therefore, when a varying magnetic field, such as an alternating magnetic field, for example as produced by an electromagnet, penetrates the magnetic material, the orientation of the magnetic dipoles changes with the varying applied magnetic field. Such magnetic dipole reorientation causes heat to be generated in the magnetic material.

When an object is both electrically-conductive and magnetic, penetrating the object with a varying magnetic field can cause both Joule heating and magnetic hysteresis heating in the object.

Moreover, the use of magnetic material can strengthen the magnetic field, which can intensify the Joule heating.

In some embodiments, the heating material may be a metal such as aluminum, gold or silver, for example in the form of a foil. In some embodiments, the heating material may be a ferromagnetic material. Examples of ferromagnetic materials include metals such as iron, nickel and cobalt, and metal alloys such as certain types of stainless steel, e.g. grade 430 stainless steel. In some embodiments, the heating material may be ferromagnetic stainless steel, for example in the form of a foil.

In some examples, the heating material may have a thermal conductivity in the range 1 W/(m·K) to 500 W/(m·K). For example, the heating material may have a thermal conductivity in the range 10 W/(m·K) to 60 W/(m·K), 100 W/(m·K) to 250 W/(m·K), 150 W/(m·K) to 250 W/(m·K), or 200 W/(m·K) to 250 W/(m·K). In some examples, the heating material may have a specific heat capacity in the range 100 J/(kg·K) to 1000 J/(kg·K). For example, the heating material may have a specific heat capacity in the range 450 J/(kg·K) to 550 J/(kg·K), 800 J/(kg·K) to 1000 J/(kg·K), or 900 J/(kg·K) to 1000 J/(kg·K).

In each of the above processes, as heat is generated inside the object itself, rather than by an external heat source by heat conduction, a rapid temperature rise in the object and more uniform heat distribution can be achieved, particularly through selection of suitable object material and geometry, and suitable varying magnetic field magnitude and orientation relative to the object. Moreover, as induction heating and magnetic hysteresis heating do not require a physical connection to be provided between the source of the varying magnetic field and the object, design freedom and control over the heating profile may be greater, and cost may be lower.

The terms ‘upstream’ and ‘downstream’ used herein are relative terms defined in relation to the direction of mainstream aerosol drawn though an article or device in use.

In the figures described herein, like reference numerals are used to illustrate like features, articles or components.

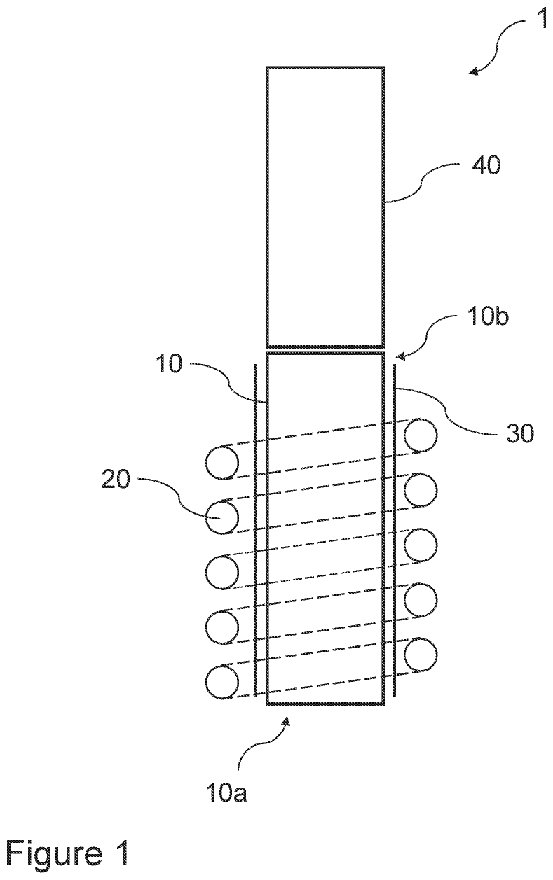

FIG. 1 is a side-on cross-sectional view of an aerosol-generating article. The aerosol generating article is for use with a non-combustible aerosol provision device.

The aerosol-generating article 1 comprises a continuous rod of aerosol-generating material 10 and a coil 20 disposed around the rod of aerosol-generating material 10. The aerosol-generating material may be any of the aerosol-generating materials described herein. In the present example, the aerosol-generating material is tobacco material.

The coil 20 comprises heating material. In the present example, the coil 20 consists entirely of aluminum. In other examples, the coil may consist of at least one material selected from the following: gold, iron, nickel, cobalt, copper, conductive carbon and graphite. In some examples, the coil may consist of a metal alloy, e.g. bronze, plain-carbon steel, stainless steel or ferritic stainless steel.

In use, the heating material of the coil 20 is heated by a varying magnetic field generated by the non-combustible aerosol provision device. The heat generated in the coil 20 is transferred to the aerosol-generating material 10 through the wrapper 30, resulting in heating of the aerosol-generating material 10.

The aerosol-generating article 1 also comprises a wrapper 30 surrounding the rod of aerosol-generating material 10. The wrapper 30 defines a cavity in which the aerosol generating material is disposed. The coil 20 is disposed around the wrapper 30.

In the present example, the wrapper 30 comprises paper. The wrapper 30 has a permeability below 500 Coresta units (CU). In some examples, the wrapper may have a permeability below 400 CU, 300 CU, 200 CU or 100 CU. Using a wrapper with permeability below 500 Coresta units reduces the flammability of the wrapper, which minimizes the risk of the wrapper igniting, for instance if a consumer were to attempt to light the article 1 using a flame. In the present example, the wrapper 30 has a permeability of about 0 CU. In other examples, the wrapper may have a permeability of 30 CU, 40 CU, 60 CU, 70 CU or 80 CU. In addition or as an alternative to a paper having a permeability below 500 CU, the wrapper 30 can comprise a burn-retardant additive. The burn-retardant additive may, for instance, prevent or limit combustion of the wrapper 30 when exposed to a flame.

In some examples, the wrapper may consist of paper only. In other examples, the wrapper may consist of a metal layer, or include a metal layer in addition to the paper. For example, the wrapper may comprise a layer of aluminum foil. Such a metal layer may assist in transferring heat evenly throughout the aerosol-generating material in the article. This may help to prevent any particular region of the aerosol generating material from reaching its combustion temperature.

In the present example, the aerosol-generating article 1 comprises a mouthpiece 40 connected to the rod of aerosol-generating material 10. In some examples, the mouthpiece may be omitted.

In the present example, the rod of aerosol-generating material 10 is substantially cylindrical with a substantially circular cross-section. In other examples, the rod of aerosol-generating material may have other cross-sections, such as an oval or elliptical cross-section. In some examples, the rod of aerosol-generating material may have a rectangular, square, triangular, or star-shaped cross-section. In some examples, the rod of aerosol-generating material may have an irregular cross-section. In some examples, the cross-sectional shape of the coil may be chosen to correspond to the cross-sectional shape of the rod of aerosol-generating material.

In the present example, the rod of aerosol-generating material 10 is elongate and has a longitudinal axis (not shown). In the present example, the coil 20 has a longitudinal axis (not shown) which is aligned with the longitudinal axis of the rod 10. In other words, the rod of aerosol-generating material 10 and the coil 20 share a common longitudinal axis. This common longitudinal axis may be referred to as a longitudinal axis of the article 1.

In the present example, the coil 20 extends from the upstream longitudinal end 10a of the rod of aerosol-generating material 10 in a direction parallel to the longitudinal axis of the article 1, but does not extend as far as the downstream longitudinal end 10b of the rod of aerosol-generating material 10. In other words, the coil 20 extends only partially along the rod of aerosol-generating material 10. In the present example, the coil 20 extends along approximately 70% of the length of the rod of aerosol-generating material 10. In other examples, the coil may extend along 20%, 30%, 40%, 50%, 60%, 80% or 90% of the length of the rod of aerosol-generating material.

In the present example, the coil 20 has the shape of a circular helix. That is, the coil 20 has a substantially constant radius along its length. In the present example, the coil 20 has a substantially constant pitch along its length. That is, a width measured parallel to the longitudinal axis of the coil 20 of a gap between any two adjacent turns of the coil 20 is substantially the same as a width of a gap between any other two adjacent turns of the coil 20. In other examples, the pitch of the coil may vary along its length.

The length of the aerosol-generating article 1 may be between about 80 mm and about 150 mm. In the present example, the aerosol-generating article has a length of about 120 mm.

The width (or diameter) of the aerosol-generating article 1 may be between about 4 mm and about 10 mm. In the present example, the aerosol-generating article has a width, or diameter, of about 7.3 mm.

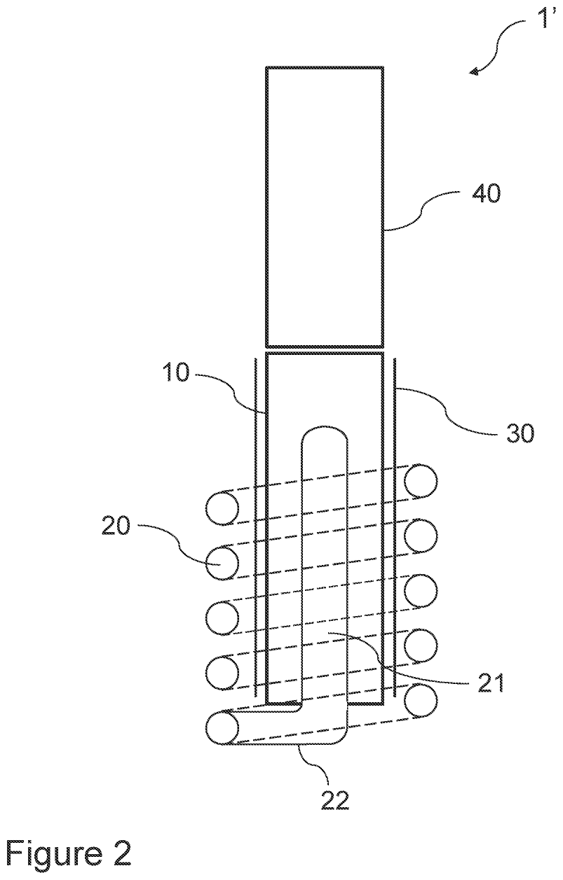

FIG. 2 is a side-on cross-sectional view of an aerosol-generating article. The aerosol generating article 1′ shown in FIG. 2 is for use with a non-combustible aerosol provision device, and is similar to the aerosol-generating article 1 shown in FIG. 1.

The aerosol-generating article 1′ comprises an elongate member 21 disposed within the rod of aerosol-generating material 10, and a connecting member 22 which connects an upstream end of the coil 20 to an upstream end of the elongate member 21.

The elongate member 21 comprises a thermally conductive material, such as a metal. This can aid in transferring heat throughout the rod of aerosol-generating material 10 in use. In some examples, the elongate member 21 comprises a thermally conductive material that is heatable by penetration with a varying magnetic field. This allows heat to be generated in both the coil 20 and the elongate member 21 during use.

In the present example, the elongate member 21 consists entirely of aluminum. In other examples, the elongate member may consist of at least one material selected from the following: gold, iron, nickel, cobalt, copper, conductive carbon and graphite. In some examples, the elongate member may consist of a metal alloy, e.g. bronze, plain-carbon steel, stainless steel or ferritic stainless steel. The elongate member may comprise, for example, resistance wire or ribbon, such as Kanthal® wire or ribbon.

In the present example, the elongate member 21 has a longitudinal axis which is aligned with the longitudinal axis of the article 1′. In other words, the elongate member 21 extends along the longitudinal axis of the article 1′. In some examples, the elongate member may extend parallel to the longitudinal axis of the article.

In the present example, the elongate member 21 is substantially cylindrical. In the present example, the elongate member 21 has a diameter of 2.5 mm. In some examples, the elongate member 21 may have a diameter in the range 1.5 mm to 3 mm. In other examples, the elongate member may be substantially planar.

In the present example, the elongate member 21 is encircled by the aerosol-generating material 10. In other words, the aerosol-generating material 10 extends around the elongate member 21.

In the present example, the elongate member 21 is impermeable to air or volatilized material, and is substantially free of discontinuities. The elongate member 21 may thus be relatively easy to manufacture. However, in some examples, the elongate member may be permeable to air and/or permeable to volatilized material created when the aerosol-generating material 10 is heated. This may help air passing through the article 1′ to pick up the volatilized material created when the aerosol-generating material 10 is heated.

The connecting member 22 comprises thermally conductive material that is heatable by penetration with a varying magnetic field. In the present example, the connecting member 22 consists entirely of aluminum. In use, the connecting member 22 acts to transfer heat generated in the coil 20 directly to the elongate member 21. This aids in efficiently transferring heat throughout the aerosol-generating material 10.

In the present example, the coil 20, the elongate member 21 and the conductive member 22 are integrally formed. In other words, the coil 20, the elongate member 21 and the connecting member 22 are formed as a single member.

In some examples, the article 1′ may comprise a catalytic material on at least a portion of the elongate member 21. The catalytic material may be provided on all of the elongate member 21, or on only some portion(s) of the elongate member 21. The catalytic material may take the form of a coating on the elongate member 21. The provision of such a catalytic material on the elongate member 21 means that, in use, the article 1′ may have a heated, chemically active surface. The catalytic material may comprise one or more materials selected from the group consisting of: aluminosilicate material, iron, vanadium, platinum or nickel.

In use, the catalytic material may act to convert, or increase the rate of conversion of, a potential irritant to something that is less of an irritant. In use, the catalytic material may act to convert, or increase the rate of conversion of, formic acid to methanol, for example. In other embodiments, the catalytic material may act to convert, or increase the rate of conversion of, other chemicals, such as acetylene to ethane by hydrogenation, or ammonia to nitrogen and hydrogen. The catalytic material may additionally or alternatively act to react, or increase the rate of reaction of, carbon monoxide and water vapor to form carbon dioxide and hydrogen (the water-gas shift reaction, or WGSR).

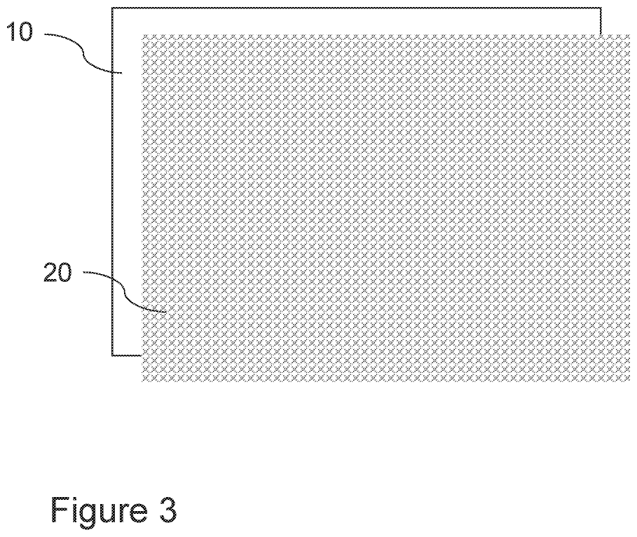

FIG. 3 is a schematic plan view of components used to form an aerosol-generating article.

The components shown in FIG. 3 include a sheet 10 comprising aerosol-generating material, and a mesh 20 comprising heating material.

The aerosol-generating material may be any of the aerosol-generating materials described herein. In the present example, the aerosol-generating material is tobacco material. In the example shown in FIG. 3, a single continuous sheet of aerosol-generating material 10 is provided. In other examples, multiple discrete sheets or strips of aerosol-generating material may be used.

In the present example, the mesh 20 consists entirely of aluminum. In other examples, the mesh may consist of at least one material selected from the following: gold, iron, nickel, cobalt, copper, conductive carbon and graphite. In some examples, the mesh may consist of a metal alloy, e.g. bronze, plain-carbon steel, stainless steel or ferritic stainless steel.

As used herein, the term “mesh” refers to a structure made of connected strands of heating material, with regularly spaced openings, or holes, between the strands. In the example shown in FIG. 3, the openings are diamond-shaped; however, this is not intended to be limiting. In other examples, the mesh may include openings with other shapes. For example, the mesh may include square, rectangular, hexagonal or circular openings.

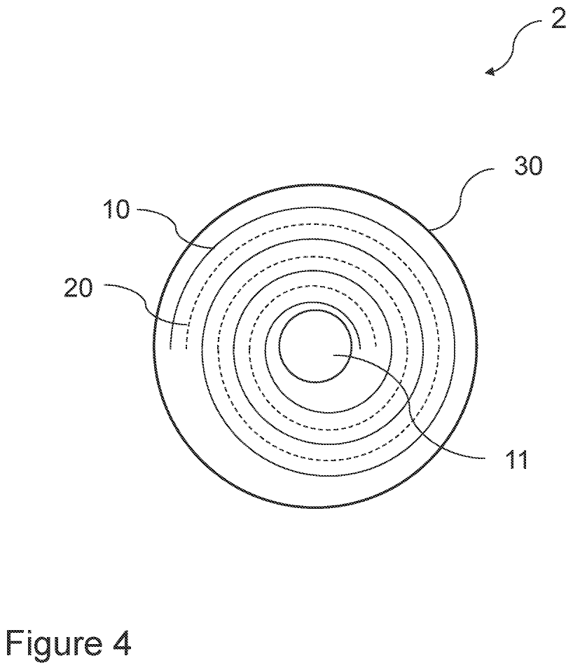

In this example, the sheet 10 and the mesh 20 are planar, or substantially planar. However, the sheet 10 and the mesh 20 are bendable or rollable so as to form a rolled sheet, for example as shown in FIG. 4. By “rolled sheet”, it is meant that the sheet 10 and the mesh 20 are curved, such as without folding, so that the sheet 10 and the mesh 20 have a spiral shape when viewed in cross-section. Such a rolled sheet may be less prone to damage, more convenient to store and handle, and better suited for use with an aerosol-provision device than a planar sheet.

In this example, the mesh 20 is disposed on a first surface of the sheet 10, and is in contact with the aerosol-generating material of the sheet 10. More specifically, in this example, all or substantially all of the first surface of the sheet 10 is covered by the mesh 20. However, in other examples, the first surface of the sheet 10 may be only partially covered by the mesh 20. Further, in some examples, a second mesh (not shown) may be provided on a second surface of the sheet 10 opposite to the first surface. In some examples, all or substantially all, or only a portion of each of the first and second surfaces of the sheet 10 may be covered by a mesh comprising heating material.

In some examples, the mesh of heating material may be embedded in the sheet of aerosol-generating material. In some examples, the mesh of heating material may not be in direct contact with the sheet, but may still be in thermal communication with the sheet so that heat generated in the heating material in use can still heat the aerosol generating material.

FIG. 4 is an end-on cross-sectional view of an aerosol-generating article. The aerosol generating article is for use with a non-combustible aerosol provision device.

The article 2 of FIG. 4 comprises a rolled sheet, which is formed from the components described above with reference to FIG. 3. In other words, the rolled sheet comprises a sheet comprising aerosol-generating material 10 and a mesh comprising heating material 20. As shown in FIG. 4, the rolled sheet has a spiral cross-section.

In the present example, the article 2 is elongate and cylindrical with a substantially circular cross section. The article 2 has a longitudinal axis (not shown). The rolled sheet of the article 2 has an axial length that is greater than a diameter (or width perpendicular to the axial length) of the rolled sheet.

In use, heat is generated in the heating material 20 of the rolled sheet. Since the heating material 20 is in contact with the aerosol-generating material 10 of the rolled sheet, heat is easily transferred from the heating material 20 to the aerosol-generating material 10. In addition, the openings in the mesh 20 may act as thermal breaks to control the degree to which different regions of the aerosol-generating material 10 are heated. Areas of aerosol generating material in thermal contact with the mesh may be heated to a lesser extent compared to arrangements in which areas of aerosol-generating material are in thermal contact with a continuous sheet of heating material. This may help progressive heating of the aerosol-generating material, and thus progressive generation of aerosol, to be achieved. The openings may be used to optimize the creation of complex eddy currents in use.

In the present example, the article 2 comprises an adhesive (not shown) that is disposed between overlapping portions of the rolled sheet and adheres these overlapping portions to each other. This helps to prevent the rolled sheet from unravelling. The adhesive may be an adhesive such as polyvinyl acetate (PVA) or ethylene-vinyl acetate (EVA). In other examples, adhesives such as a polysaccharide-based adhesive may be used. The adhesive can, for instance, comprise guar gum, pectin, an alginate or a combination thereof. The alginate can, for instance, comprise sodium alginate.

In the present example, the article 2 also comprises a mass of aerosol-generating material 11 that is discrete from, and encircled by, the rolled sheet. In use, heat is generated in the heating material 20, and the rolled sheet helps to retain this heat within the article 2. This arrangement also helps to enable the generated heat to heat the mass of aerosol-generating material 11 in use. In this example, all of the mass of aerosol-generating material 11 is located along the longitudinal axis of the article 2. In other examples, some of the mass of aerosol generating material may be located at other positions within the article 2. For example, at least a portion of the mass of aerosol-generating material may be sandwiched between overlapping portions of the rolled sheet. In some examples, the mass of aerosol-generating material may be omitted, or may be annular in shape. In such examples, the article 2 may be annular in shape.

In the present example, the article 2 also comprises a wrapper 30 surrounding the rolled sheet and a mouthpiece (not shown) connected to the rolled sheet. In some examples, the mouthpiece may be omitted. The wrapper may be any of the wrappers described above in relation to the examples shown in FIGS. 1 and 2.

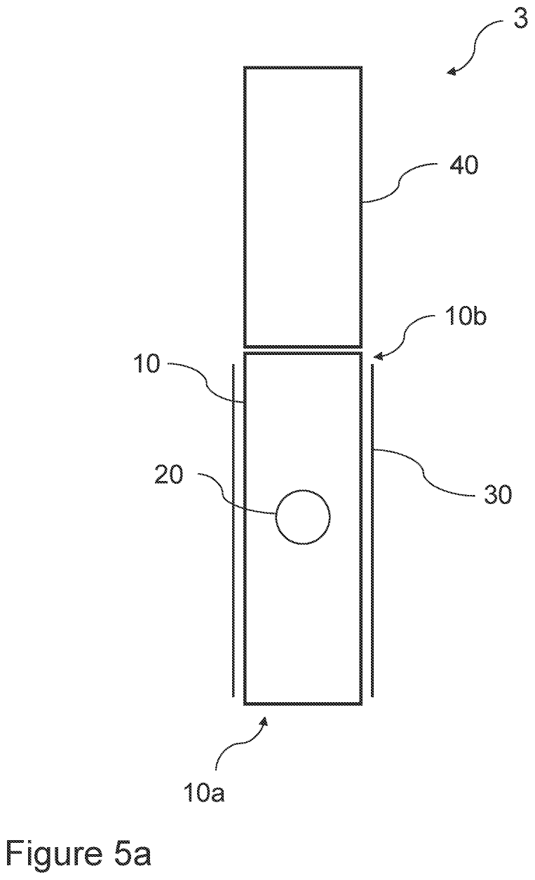

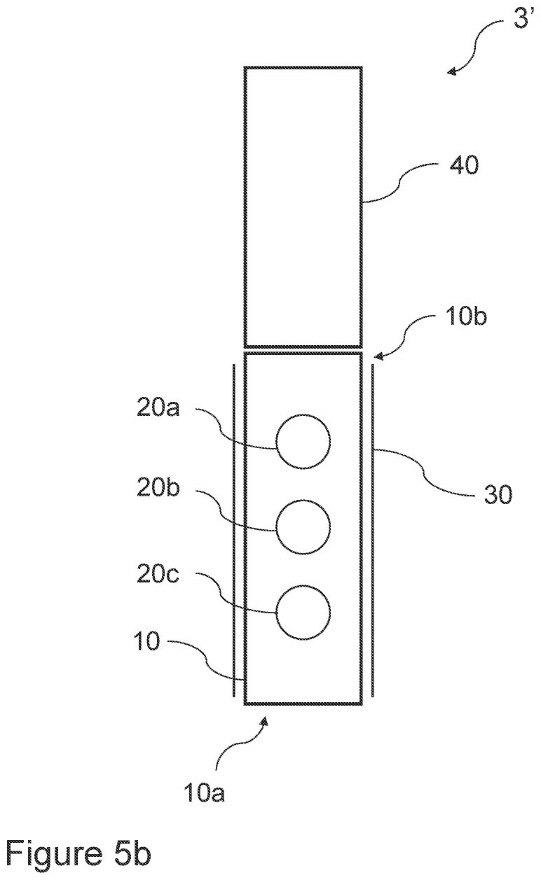

FIG. 5a is a side-on cross sectional view of an aerosol-generating article. The aerosol generating article is for use with a non-combustible aerosol provision device.

The article 3 comprises a continuous rod of aerosol-generating material 10. The rod 10 is elongate and has a longitudinal axis. The rod 10 includes an axial region which is centered on the longitudinal axis of the article 3 and extends along the longitudinal axis.

In the present example, the article 3 comprises a single body 20 disposed in the axial region of the rod of aerosol-generating material 10. The body 20 comprises heating material. In the present example, the body 20 consists entirely of Grade 430 stainless steel. In other examples, the elongate member may consist of at least one material selected from the following: aluminum, gold, iron, nickel, cobalt, copper, conductive carbon and graphite. In some examples, the elongate member may consist of a metal alloy, e.g. bronze or plain-carbon steel.

In some examples, the article 3 may comprise a catalytic material on at least a portion of the body 20. The catalytic material may be provided on all of the body 20, or on only some portion(s) of body 20. The catalytic material may take the form of a coating on the body 20. The provision of such a catalytic material on the body 20 means that, in use, the article 3 may have a heated, chemically active surface. The catalytic material may comprise one or more materials selected from the group consisting of: aluminosilicate material, iron, vanadium, platinum or nickel.

The rod of aerosol-generating material 10 has an upstream end 10a and a downstream end 10b and the single body 20 is disposed in the axial region of the rod of aerosol-generating material 10 such that it is approximately centrally located between the upstream and downstream ends 10a, 10b. However, in other examples, it can be beneficial to locate the body 20 in a non-central location, for instance closer to the downstream end 10b than to the upstream end 10a. For instance, the center of the body 20 can be located between about 25% and about 45% of the distance from the downstream end 10b to the upstream end 10a. This can help to ensure that the body 20 is held in the rod of aerosol-generating material 10 and reduce the likelihood of it falling out of the upstream end 10a.

In some examples, more than one body may be provided. FIG. 5b shows an example of an aerosol-generating article 3′ which includes three bodies 20a, 20b, 20c. In this example, the bodies 20a, 20b, 20c are spaced evenly along the longitudinal axis of the rod 10. In other words, the distance between any two adjacent bodies is the same as the distance between any other two adjacent bodies. Consecutive bodies are spaced by at least about 2 mm, at least about 3 mm or at least about 4 mm. In some examples the spacing is about 3 mm, about 4 mm or about 5 mm, or between about 2 mm and about 10 mm, for instance between about 3 mm and about 6 mm.

In the examples shown in FIGS. 5a and 5b, the bodies are substantially spherical and have circular cross-sections. The bodies have a diameter of approximately 2 mm. In other examples, the bodies may have a diameter of approximately 0.5 mm, 1 mm, 1.5 mm, 2.5 mm, 3 mm, 3.5 mm, 4 mm, 4.5 mm or 5 mm.

The one or more bodies 20, 20a, 20b, 20c can be substantially spherical with a diameter of between about 1 mm and about 5 mm, for instance between about 2 mm and about 4 mm or about 3 mm or about 3.5 mm. In some examples, the diameter of the one or more bodies 20, 20a, 20b, 20c is between 30% and 70% of the diameter of the aerosol-generating article, for instance between about 40% and 60%, or about 50%.

The one or more bodies can be solid or hollow. Advantageously, a hollow body can provide circular paths for current to flow through the material forming the body, for instance in cases in which the body is formed from an electrically conductive material. This can enhance heat generation in the body. Where the bodies are hollow, they can have a wall thickness between about 0.5 mm and about 3 mm, for instance of about 1 mm. Additionally or alternatively, the one or more bodies can be porous or permeable. For instance, the material forming the one or more bodies can be an open cell foam material, or other porous material. If provided as a hollow body, the wall of the body can be porous or permeable, for instance having a pattern of apertures in the wall. The wall can, for instance, be formed as a mesh formed into a sphere.

In some examples, the bodies may be substantially cylindrical and have circular cross sections. In such examples, the bodies may have a diameter of approximately 0.5 mm, 1 mm, 1.5 mm, 2 mm, 2.5 mm, 3 mm, 3.5 mm, 4 mm, 4.5 mm or 5 mm.

In the examples shown in FIGS. 5a and 5b, the articles 3, 3′ comprise a wrapper 30 surrounding the rod of aerosol-generating material 10 and a mouthpiece 40 connected to the rod of aerosol-generating material 10. In some examples, the mouthpiece may be omitted. The wrapper 30 may be any of the wrappers described above in relation to the examples shown in FIGS. 1 and 2.

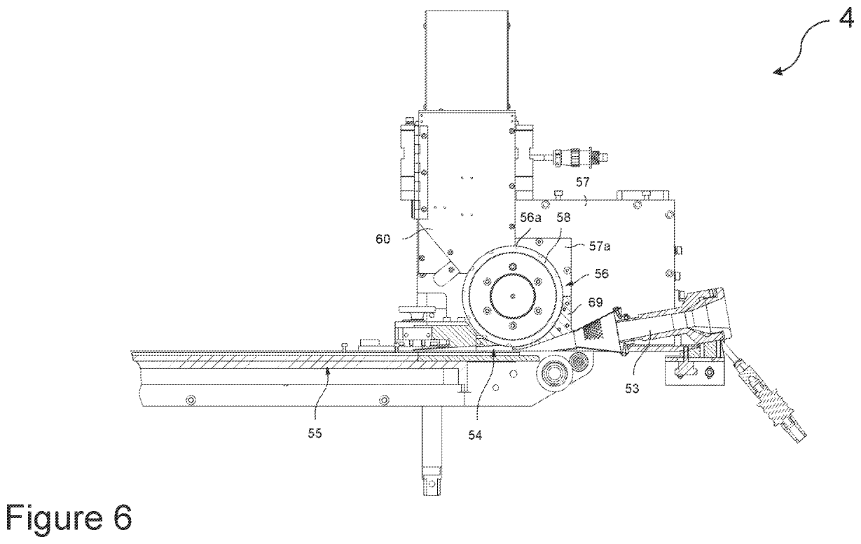

FIG. 6 shows part of an apparatus 4 which can be used in the manufacture of the articles shown in FIGS. 5a and 5b. In operation, tobacco material is drawn from a source, stretched in a set of stretching rollers (not shown) and compressed through stuffer jet 53 and through the tongue 54 of garniture 55. In other examples, the stretching rollers and/or stuffer jet can be omitted, for instance in cases in which the tobacco material is in a form which may be degraded by the use of those components. As shown, the apparatus 4 has a rotatable transport wheel 56. The rotatable transport wheel 56 includes a plurality of recesses 56a and is arranged to deliver bodies of heating material from the circumferential recesses 56a directly into the tongue 54 so that the bodies come into contact with tobacco material passing therethrough. The tobacco material is wrapped in a wrapper, for instance a paper wrapper, in the garniture to form an elongate rod which is then cut to form rod segments, each of which contains a desired number of bodies of heating material, for example one body, two bodies, three bodies, four bodies or five bodies.

The transport wheel 56 is vertically orientated and rotatably mounted to the body 57 of the apparatus 4 on a shaft. The wheel 56 has a disk section 58 and a front section 59 bolted to the disk section 56. The disk section 58 is arranged between a hopper 60 and the tongue 54 and is configured to sequentially transfer bodies of heating material therebetween.

The tongue 54 of the garniture 55 is tapered along its length so as to radially compress the tobacco material as it passes through the tongue 54. An opening is formed in the top of the tongue 54, the opening being wide enough to receive the disk section 58 of the transport wheel 56, which penetrates into the tongue 54 through the opening as shown in FIG. 6.

As the wheel 56 rotates, bodies of heating material fall under gravity from the hopper 60 into the plurality of recesses 56a arranged circumferentially around the rim of the disk section 58, as shown in FIG. 6. The clockwise rotating wheel 56 carries the bodies of heating material through the opening in the top of the tongue and into the tongue interior, where the bodies of heating material exit the wheel 56 and pass into the rod being formed. Housing 57a is provided around the rim of disk section 58 to prevent the bodies of heating material from falling from the wheel 56.

Thus, the bodies of heating material are delivered directly into the tongue of the garniture, where the path of the tobacco material is steady and controlled, remaining so until the rod is formed. Furthermore, since the bodies of heating material are inserted during compression of the tobacco material, the tobacco material is compressed around the bodies of heating material and thus secures them in position. Accordingly, the position and spacing of the bodies of heating material in the finished rod depends only on the position that the bodies of heating material are placed in the tobacco material passing through the tongue. Thus, the apparatus allows the position of the bodies of heating material to be precisely controlled, with little variation from body to body or from rod to rod. In some embodiments, the bodies of heating material are positioned in the tobacco material so as to be disposed in an axial region of the finished rod.

The bodies of heating material exiting the wheel 56 may drop under gravity from the recesses 56a of the wheel 56 into the tobacco material passing through the tongue 54. Alternatively, the transport wheel 56 may have an ejection mechanism, for example an air-jet propulsion mechanism, configured to sequentially eject the bodies of heating material from the recesses in the rim section 58 and into the tobacco material passing through the tongue 54. The transport wheel may alternatively, or in addition comprise a suction pump configured to apply suction to the bodies of heating material to hold them in position in the recesses before ejection.

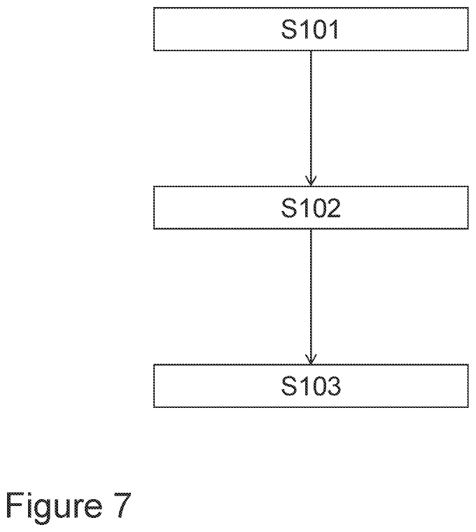

Also presented herein is a method of manufacturing an aerosol-generating article for use with a non combustible aerosol provision device. The method is shown in FIG. 7 and comprises: transferring aerosol-generating material along a transfer path (S101); inserting one or more bodies into an axial region of the aerosol-generating material, wherein the one or more bodies have a circular cross-section and have a diameter in the range 0.5 mm to 5 mm, and wherein the one or more bodies comprise heating material that is heatable by penetration with a varying magnetic field (S102); and forming the aerosol-generating material into a continuous rod of aerosol generating material (S103).

Inserting the bodies into the axial region of the aerosol-generating material can be performed such that consecutive bodies are spaced by at least about 2 mm, at least about 3 mm or at least about 4 mm. For instance, the distance between the recesses 56a of the wheel 56 can determine the spacing of bodies in the aerosol-generating material. In some examples the spacing is about 3 mm, about 4 mm or about 5 mm. The spacing between bodies can provide a region of the continuous rod at which the rod can be cut to form individual segments and/or groups of individual segments for use in the manufacture of articles.

The method can further comprise cutting the continuous rod of aerosol-generating material to provide rod segments and forming the rod segments into one or more articles. Forming the rod segments into one or more articles can include forming the rod segments into one or more aerosol-generating sections each having an upstream end and a downstream end in the finished article, and a body of heating material disposed in the aerosol-generating section closer to the downstream end than the upstream end of the aerosol-generating section. In alternative embodiments, the body of heating material can be approximately centrally located between the downstream and the upstream end.

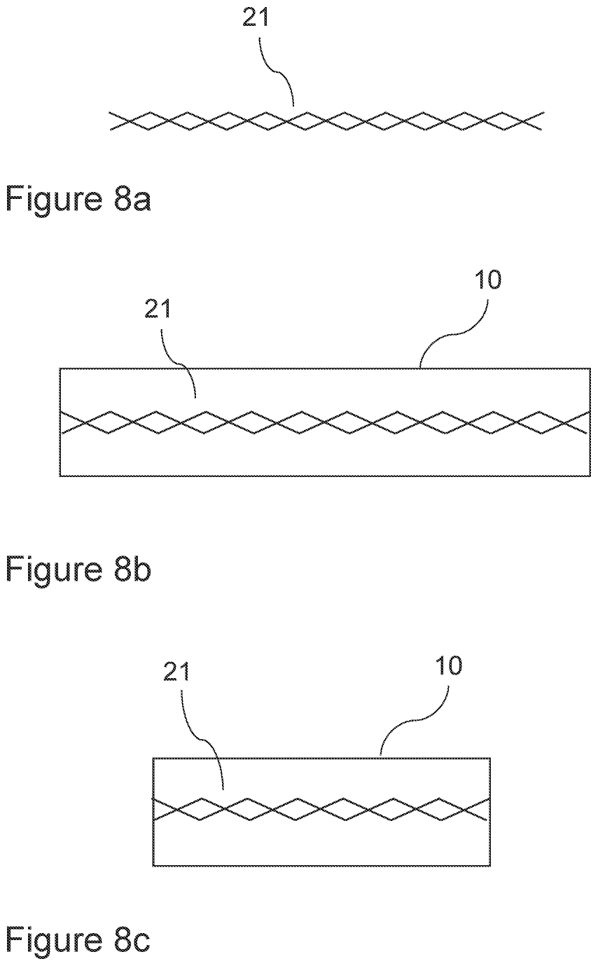

FIGS. 8a, 8b and 8c show an example of a method for manufacturing an aerosol-generating article and a body or material comprising one or more filaments. The aerosol generating article is for use with a non-combustible aerosol provision device.

Referring to FIG. 8a, one or more filaments 21 comprising heating material as described herein are provided, for instance heating material which can be inductively heated when exposed to a varying magnetic field. The method comprises transferring aerosol-generating material 10, in the present case tobacco material, along a transfer path. The method further comprises feeding the one or more filaments 21 into the aerosol-generating material 10 so that the filaments 21 are surrounded by the aerosol-generating material 10, as shown in FIG. 8b. The filaments 21 may be fed from a source, such as a spool, via an outlet.

In the present example, the filaments 21 consist entirely of aluminum. In other examples, the filaments may comprise or consist of at least one material selected from the following: gold, iron, nickel, cobalt, copper, conductive carbon and graphite. In some examples, the filaments may comprise or consist of a metal alloy, e.g. bronze, plain-carbon steel, stainless steel or ferritic stainless steel, such as grade 430 stainless steel. The filaments may comprise, for example, resistance wire or ribbon, such as Kanthal® wire or ribbon. The rod or body 10 of aerosol-generating material can include a filament formed as a single strand of material, or a filament formed from multiple strands. For instance, a plurality of metal or other material fibers can be formed into a multi-strand wire or thread, and used as an individual filament 21. Multiple filaments can be fed into the aerosol-generating material, such that they are distributed within the rod or body 10 of aerosol-generating material. For instance, the rod or body 10 of aerosol-generating material can include between 1 and 20 filaments, for instance between 2 and 10 filaments, or between 3 and 6 filaments.

The feeding of the filaments 21 may be effected by, for example, using a mechanical or electromechanical delivery device such as feed rollers, or a conveyor. Such a mechanical or electromechanical delivery device may have its delivery speed adjusted so as to meter the filaments 21 into the aerosol-generating material 10 at an appropriate rate, for instance on the basis of the speed of the aerosol-generating material 10 past the outlet. The combination of the filaments 21 and aerosol-generating material 10 may pass through a tongue of a garniture, where it may be wrapped with a wrapper.

The provision of the filaments 21 in the aerosol-generating material 10 forms an elongate assembly comprising the filaments 21 within the aerosol-generating material 10.

The elongate assembly is cut at a predetermined longitudinal position along the elongate assembly to form a continuous rod of aerosol-generating material 10, also referred to as a body of aerosol-generating material 10. In the example shown in FIG. 8c, the filaments 21 extend to opposite longitudinal ends of the rod or body of aerosol-generating material 10, for instance extending the full length of the rod or body. The rod or body of aerosol-generating material 10 can be used with a non-combustible aerosol-provision device which is arranged to heat the heating material by induction. Alternatively, the rod or body of aerosol-generating material 10 can be formed into an article, for instance by connection of one or more additional components to the rod or body, such as a mouthpiece component. The article can be used with a non-combustible aerosol-provision device which is arranged to heat the heating material by induction.

In other examples, the formation of the article may not require cutting of an elongate assembly. In some such examples, the filaments 21 may be the filaments 21 of the article being manufactured, the aerosol-generating material 10 may itself form the rod of aerosol-generating material 10 of the article being manufactured. In some such examples, the one or more filaments may not extend to opposite longitudinal ends of the rod of aerosol-generating material 10.

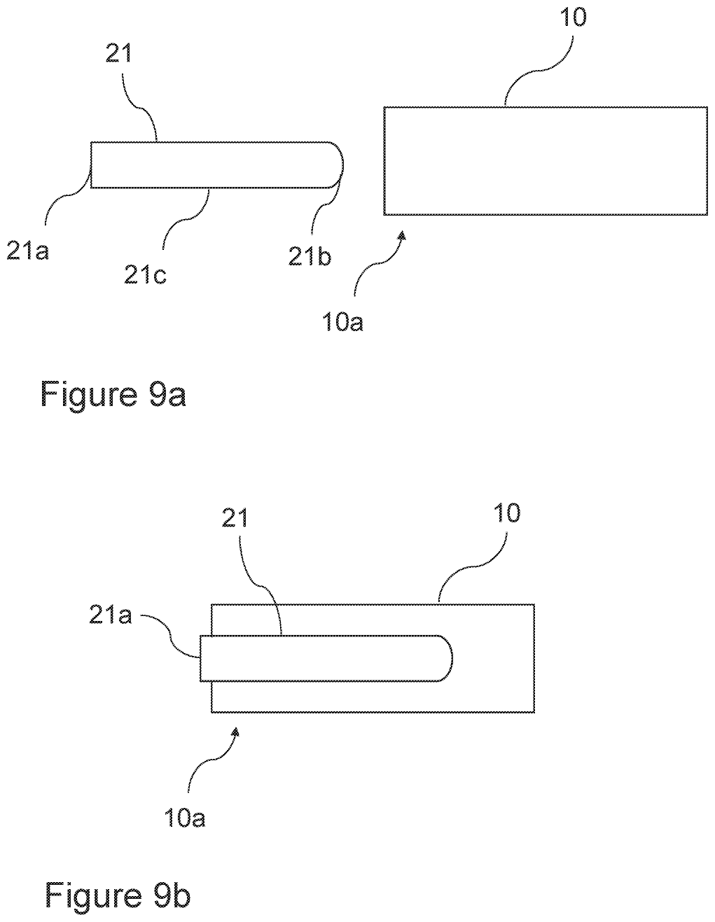

FIGS. 9a and 9b show an example of a method for manufacturing an aerosol-generating article. The aerosol generating article is for use with a non-combustible aerosol provision device.

The method comprises providing a continuous rod of aerosol-generating material 10 and an elongate member 21 comprising heating material, as shown in FIG. 9a. In the present example, the aerosol-generating material is tobacco material.

In the present example, the elongate member 21 is substantially cylindrical in shape and has a first longitudinal end surface 21a, a second longitudinal end surface 21b and a lateral surface 21c. In the present example, the elongate member 21 has a diameter of 2.5 mm. In some examples, the elongate member 21 may have a diameter in the range 1.5 mm to 3 mm. In other examples, the elongate member may be planar.

In the present example, the elongate member 21 consists entirely of aluminum. In other examples, the elongate member may consist of at least one material selected from the following: gold, iron, nickel, cobalt, copper, conductive carbon and graphite. In some examples, the elongate member may consist of a metal alloy, e.g. bronze, plain-carbon steel, stainless steel or ferritic stainless steel. The elongate member may comprise, for example, resistance wire or ribbon, such as Kanthal® wire or ribbon.

The method further comprises inserting the elongate member 21 into a longitudinal end 10a of the rod of aerosol generating material 10. Following insertion, the elongate member 21 is encircled by the aerosol-generating material 10, and the first longitudinal end surface 21a of the elongate member 21 is exposed, as shown in FIG. 9b. In other words, the first longitudinal end surface 21a of the elongate member 21 is not covered by another material, such as the aerosol-generating material 10.

In this example, the elongate member 21 extends beyond the longitudinal end 10a of the rod of aerosol-generating material 10. In other examples, the elongate member 21 may be flush with the longitudinal end of the rod of aerosol-generating material.

In some examples, the method may further comprise wrapping the rod of aerosol-generating material 10 in a wrapper (not shown).

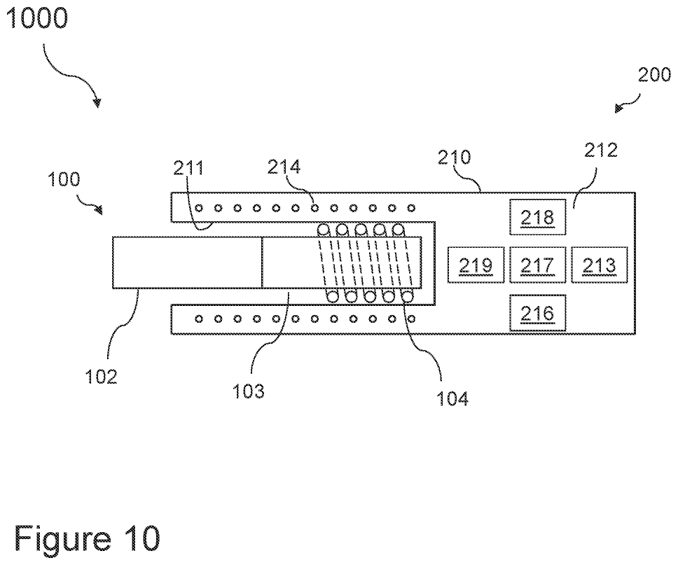

FIG. 10 is a schematic cross-sectional side view of an example of a system. The system 1000 comprises an article 100 and a non-combustible aerosol provision device 200. In the present example, the article 100 is the article shown in FIG. 1. In other examples, the article 100 may be any one of the aerosol-generating articles described herein.

The non-combustible aerosol provision device 200 comprises a body 210 and a heating zone 211 for receiving the article 100. The non-combustible aerosol provision device 200 also comprises a magnetic field generator 212 configured to generate a varying magnetic field for penetrating the heating material of the article 100 when the article 100 is located in the heating zone 211.

The device 200 may include an air inlet (not shown) that fluidly connects the heating zone 211 with the exterior of the device 200. Such an air inlet may be defined by the body 210. A user may be able to inhale aerosol generated by the aerosol-generating material of the article 100 by drawing the aerosol through the mouthpiece 102 of the article 100. As the aerosol is removed from the article 100, air may be drawn into the heating zone 211 via the air inlet of the device 200.

In the present example, the body 210 comprises the heating zone 211. In this example, the heating zone 211 comprises a recess for receiving at least a portion of the article 100. In other examples, the heating zone 211 may be a shelf, a surface, or a projection, and may require mechanical mating with the article in order to co-operate with, or receive, the article. In this example, the heating zone 211 is elongate, and is sized and shaped to accommodate a portion of the article 100. In other examples, the heating zone 211 may be dimensioned to receive the whole article.

In the present example, the magnetic field generator 212 comprises an electrical power source 213, a coil 214, a device 216 for passing a varying electrical current, such as an alternating current, through the coil 214, a controller 217, and a user interface 218 for user-operation of the controller 217.

In the present example, the electrical power source 213 is a rechargeable battery. In other examples, the electrical power source 213 may be other a non-rechargeable battery, a capacitor, a battery-capacitor hybrid, or a connection to a mains electricity supply.

The coil 214 may take any suitable form. In the present example, the coil 214 is a helical coil of electrically-conductive material, such as copper. In some examples, the magnetic field generator 212 may comprise a magnetically permeable core around which the coil 214 is wound. Such a magnetically permeable core concentrates the magnetic flux produced by the coil 214 in use and generates a more powerful magnetic field. The magnetically permeable core may be made of iron, for example. In some examples, the magnetically permeable core may extend only partially along the length of the coil 214, so as to concentrate the magnetic flux only in certain regions. In some examples, the coil may be a flat coil. That is, the coil may be a two-dimensional spiral. In the present example, the coil 214 encircles the heating zone 211. The coil 214 extends along a longitudinal axis that is substantially aligned with a longitudinal axis of the heating zone 211. The aligned axes are coincident. In other examples, the aligned axes may be parallel or oblique to each other.

In the present example, when the article 100 is received in the recess 211, as shown in FIG. 10, the longitudinal axis of the recess 211 is substantially coincident with the longitudinal axis of the article 100. In this example, an impedance of the coil 214 of the magnetic field generator 212 is equal, or substantially equal, to an impedance of the coil 104 of the article 100. If the impedance of the coil 104 of the article 100 were instead lower than the impedance of the coil 214 of the magnetic field generator 212, then the voltage generated across the coil 104 of the article 100 in use may be lower than the voltage that may be generated across the coil 104 of the article 100 when the impedances are matched. Alternatively, if the impedance of the coil 104 of the article 100 were instead higher than the impedance of the coil 214 of the magnetic field generator 212, then the electrical current generated in the coil 104 of the article 100 in use may be lower than the current that may be generated in the coil 104 of the article 100 when the impedances are matched. Matching the impedances may help to balance the voltage and current to maximize the heating power generated at the coil 104 of the article 100 when heated in use. While the system 1000 of this example comprises the article of FIG. 1, in other examples the system may comprise the article shown in FIG. 2. In such other examples, the impedance of the coil 214 of the magnetic field generator 212 may be equal, or substantially equal, to an impedance of the coil of the article.

In the present example, the device 216 for passing a varying current through the coil 214 is electrically connected between the electrical power source 213 and the coil 214. In this example, the controller 217 also is electrically connected to the electrical power source 213, and is communicatively connected to the device 216 in order to control the device 216. More specifically, in this example, the controller 217 is configured to control the device 216, so as to control the supply of electrical power from the electrical power source 213 to the coil 214. In this example, the controller 217 comprises an integrated circuit (IC), such as an IC on a printed circuit board (PCB). In other examples, the controller 217 may take a different form. In some examples, the non-combustible aerosol provision device may have a single electrical or electronic component comprising the device 216 and the controller 217.

In the present example, the controller 217 is operated by user-operation of the user interface 218. In this example, the user interface 218 is located at the exterior of the body 210. The user interface 218 may comprise a push-button, a toggle switch, a dial, a touchscreen, or the like. In other examples, a user interface remote from the non-combustible aerosol provision device may be provided. Such a user interface may be connected to the non-combustible aerosol provision device using a wireless communication method, such as Bluetooth. For example, the user interface may be implemented as part of a mobile electronic device, such as a mobile phone, which is able to communicate with the non-combustible aerosol provision device using a wireless communication method, such as Bluetooth. A user may be able to remotely control the non-combustible aerosol provision device using the user interface of their mobile phone.

In the present example, operation of the user interface 218 by a user causes the controller 217 to cause the device 216 to cause an alternating electrical current to pass through the coil 214. This causes the coil 214 to generate an alternating magnetic field. The coil 214 and the heating zone 211 of the non-combustible aerosol provision device 200 are suitably relatively positioned so that, when the article 100 is located in the heating zone 211, the varying magnetic field produced by the coil 214 penetrates the heating material of the article 100. In the present example, the varying magnetic field produced by the coil 214 penetrates the heating material of the coil 104.

In some examples, the heating material of the article is an electrically-conductive material, such as aluminum. In such examples, penetration of the heating material by a magnetic field causes the generation of one or more eddy currents in the heating material. The flow of eddy currents in the heating material against the electrical resistance of the heating material causes the heating material to be heated by Joule heating. In some examples, the heating material is a magnetic material, such as ferromagnetic stainless steel. In such examples, the orientation of magnetic dipoles in the heating material changes with the changing applied magnetic field, which causes heat to be generated in the heating material.

The non-combustible aerosol provision device 200 comprises a temperature sensor 219 configured to sense a temperature of the heating zone 211. The temperature sensor 219 is communicatively connected to the controller 217, so that the controller 217 is able to monitor the temperature of the heating zone 211. On the basis of one or more signals received from the temperature sensor 219, the controller 217 may cause the device 216 to adjust a characteristic of the varying or alternating electrical current passed through the coil 214 as necessary, in order to ensure that the temperature of the heating zone 211 remains within a predetermined temperature range. The characteristic may be, for example, amplitude or frequency or duty cycle. Within the predetermined temperature range, in use the aerosol-generating material within an article located in the heating zone 211 is heated sufficiently to volatilize at least one component of the aerosol-generating material without combusting the aerosol-generating material. Accordingly, the controller 217, and the device 200 as a whole, is arranged to heat the aerosol-generating to volatilize the at least one component of the aerosol-generating material without combusting the aerosol-generating. In some embodiments, the temperature range is about 50° C. to about 300° C., such as between about 50° C. and about 250° C., between about 50° C. and about 150° C., between about 50° C. and about 120° C., between about 50° C. and about 100° C., between about 50° C. and about 80° C., or between about 60° C. and about 70° C. In some embodiments, the temperature range is between about 170° C. and about 220° C. In other embodiments, the temperature range may be other than this range. In some embodiments, the upper limit of the temperature range could be greater than 300° C. In some embodiments, the temperature sensor 219 may be omitted. In some embodiments, the heating material may have a Curie point temperature selected on the basis of the maximum temperature to which it is desired to heat the heating material, so that further heating above that temperature by induction heating the heating material is hindered or prevented.

Articles, for instance those in the shape of rods, are often named according to the product length: “regular” (typically in the range 68-75 mm, e.g. from about 68 mm to about 72 mm), “short” or “mini” (68 mm or less), “king size” (typically in the range 75-91 mm, e.g. from about 79 mm to about 88 mm), “long” or “super-king” (typically in the range 91-105 mm, e.g. from about 94 mm to about 101 mm) and “ultra-long” (typically in the range from about 110 mm to about 121 mm).

They are also named according to the product circumference: “regular” (about 23-25 mm), “wide” (greater than 25 mm), “slim” (about 22-23 mm), “demi-slim” (about 19-22 mm), “super-slim” (about 16-19 mm), and “micro-slim” (less than about 16 mm).

Accordingly, an article in a king-size, super-slim format will, for example, have a length of about 83 mm and a circumference of about 17 mm.

Each format may be produced with mouthpieces of different lengths. The mouthpiece length will be from about 30 mm to 50 mm. A tipping paper connects the mouthpiece to the aerosol generating material and will usually have a greater length than the mouthpiece, for example from 3 to 10 mm longer, such that the tipping paper covers the mouthpiece and overlaps the aerosol generating material, for instance in the form of a rod of substrate material, to connect the mouthpiece to the rod.

Articles and their aerosol generating materials and mouthpieces described herein can be made in, but are not limited to, any of the above formats.

In some embodiments, the substance to be delivered may be an aerosol-generating material or a material that is not intended to be aerosolized. As appropriate, either material may comprise one or more active constituents, one or more flavors, one or more aerosol-former materials, and/or one or more other functional materials.

An aerosol generator is an apparatus configured to cause aerosol to be generated from the aerosol-generating material. In some embodiments, the aerosol generator is a heater configured to subject the aerosol-generating material to heat energy, so as to release one or more volatiles from the aerosol-generating material to form an aerosol. In some embodiments, the aerosol generator is configured to cause an aerosol to be generated from the aerosol-generating material without heating. For example, the aerosol generator may be configured to subject the aerosol-generating material to one or more of vibration, increased pressure, or electrostatic energy.

Aerosol-generating material is a material that is capable of generating aerosol, for example when heated, irradiated or energized in any other way. Aerosol-generating material may, for example, be in the form of a solid, liquid or gel which may or may not contain an active substance and/or flavorants. In some embodiments, the aerosol generating material may comprise an “amorphous solid”, which may alternatively be referred to as a “monolithic solid” (i.e. non-fibrous). In some embodiments, the amorphous solid may be a dried gel. The amorphous solid is a solid material that may retain some fluid, such as liquid, within it. In some embodiments, the aerosol-generating material may for example comprise from about 50 wt %, 60 wt % or 70 wt % of amorphous solid, to about 90 wt %, 95 wt % or 100 wt % of amorphous solid.

The aerosol-generating material may comprise one or more active substances and/or flavors, one or more aerosol-former materials, and optionally one or more other functional material.

The aerosol-former material may comprise one or more constituents capable of forming an aerosol. In some embodiments, the aerosol-former material may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate. The total amount of aerosol-former material provided can be in the range of 10% to 30%, for instance 12% to 22%, by weight, of the aerosol generating material, such as tobacco material.

The one or more other functional materials may comprise one or more of pH regulators, coloring agents, preservatives, binders, fillers, stabilizers, and/or antioxidants.

The material may be present on or in a support, to form a substrate. The support may, for example, be or comprise paper, card, paperboard, cardboard, reconstituted material, a plastics material, a ceramic material, a composite material, glass, a metal, or a metal alloy. In some embodiments, the support comprises a susceptor. In some embodiments, the susceptor is embedded within the material. In some alternative embodiments, the susceptor is on one or either side of the material.

An aerosol-modifying agent is a substance, typically located downstream of the aerosol generation area, that is configured to modify the aerosol generated, for example by changing the taste, flavor, acidity or another characteristic of the aerosol. The aerosol-modifying agent may be provided in an aerosol-modifying agent release component, that is operable to selectively release the aerosol-modifying agent.

The aerosol-modifying agent may, for example, be an additive or a sorbent. The aerosol-modifying agent may, for example, comprise one or more of a flavorant, a colorant, water, and a carbon adsorbent. The aerosol-modifying agent may, for example, be a solid, a liquid, or a gel. The aerosol-modifying agent may be in powder, thread or granule form. The aerosol-modifying agent may be free from filtration material.

As used herein, the term “tobacco material” refers to any material comprising tobacco or derivatives or substitutes thereof. The term “tobacco material” may include one or more of tobacco, tobacco derivatives, expanded tobacco, reconstituted tobacco or tobacco substitutes. The tobacco material may comprise one or more of ground tobacco, tobacco fiber, cut tobacco, extruded tobacco, tobacco stem, tobacco lamina, reconstituted tobacco and/or tobacco extract.

In some embodiments, the substance to be delivered comprises an active substance.

The active substance as used herein may be a physiologically active material, which is a material intended to achieve or enhance a physiological response. The active substance may for example be selected from nutraceuticals, nootropics, psychoactives. The active substance may be naturally occurring or synthetically obtained. The active substance may comprise for example nicotine, caffeine, taurine, theine, vitamins such as B6 or B12 or C, melatonin, cannabinoids, or constituents, derivatives, or combinations thereof. The active substance may comprise one or more constituents, derivatives or extracts of tobacco or another botanical.

In some embodiments, the active substance comprises nicotine. In some embodiments, the active substance comprises caffeine, melatonin or vitamin B12.

As noted herein, the active substance may comprise or be derived from one or more botanicals or constituents, derivatives or extracts thereof. As used herein, the term “botanical” includes any material derived from plants including, but not limited to, extracts, leaves, bark, fibers, stems, roots, seeds, flowers, fruits, pollen, husk, shells or the like. Alternatively, the material may comprise an active compound naturally existing in a botanical, obtained synthetically. The material may be in the form of liquid, gas, solid, powder, dust, crushed particles, granules, pellets, shreds, strips, sheets, or the like. Example botanicals are tobacco, Eucalyptus, Star Anise, Hemp, Cocoa, Cannabis, Fennel, Lemongrass, Peppermint, Spearmint, Rooibos, Chamomile, Flax, Ginger, Ginkgo biloba, hazel, hibiscus, laurel, licorice (liquorice), matcha, mate, orange skin, Papaya, rose, sage, tea such as green tea or black tea, thyme, clove, cinnamon, coffee, aniseed (anise), basil, bay leaves, cardamom, coriander, cumin, nutmeg, oregano, paprika, rosemary, saffron, lavender, lemon peel, mint, juniper, elderflower, vanilla, wintergreen, beefsteak plant, Curcuma, turmeric, sandalwood, cilantro, bergamot, orange blossom, myrtle, cassis, valerian, pimento, mace, damien, marjoram, olive, lemon balm, lemon basil, chive, Carvi, Verbena, tarragon, geranium, mulberry, Ginseng, theanine, theacrine, maca, ashwagandha, damiana, guarana, chlorophyll, baobab or any combination thereof. The mint may be chosen from the following mint varieties: Mentha arventis, Mentha c.v., Mentha niliaca, Mentha piperita, Mentha piperita citrata c.v., Mentha piperita c.v, Mentha spicata crispa, Mentha cardifolia, Mentha longifolia, Mentha suaveolens variegata, Mentha pulegium, Mentha spicata c.v. and Mentha suaveolens.

In some embodiments, the active substance comprises or is derived from one or more botanicals or constituents, derivatives or extracts thereof and the botanical is tobacco.

In some embodiments, the active substance comprises or derived from one or more botanicals or constituents, derivatives or extracts thereof and the botanical is selected from eucalyptus, star anise, cocoa and hemp.

In some embodiments, the active substance comprises or derived from one or more botanicals or constituents, derivatives or extracts thereof and the botanical is selected from rooibos and fennel.

In some embodiments, the substance to be delivered comprises a flavor.

As used herein, the terms “flavor” and “flavorant” refer to materials which, where local regulations permit, may be used to create a desired taste, aroma or other somatosensorial sensation in a product for adult consumers. They may include naturally occurring flavor materials, botanicals, extracts of botanicals, synthetically obtained materials, or combinations thereof (e.g., tobacco, Cannabis, licorice (liquorice), Hydrangea, eugenol, Japanese white bark Magnolia leaf, chamomile, fenugreek, clove, maple, matcha, menthol, Japanese mint, aniseed (anise), cinnamon, turmeric, Indian spices, Asian spices, herb, wintergreen, cherry, berry, red berry, cranberry, peach, apple, orange, mango, clementine, lemon, lime, tropical fruit, Papaya, Rhubarb, Grape, Durian, Dragon fruit, cucumber, blueberry, mulberry, citrus fruits, Drambuie, bourbon, scotch, whiskey, gin, tequila, rum, spearmint, peppermint, lavender, aloe vera, cardamom, celery, cascarilla, nutmeg, sandalwood, bergamot, geranium, khat, naswar, Betel, shisha, pine, honey essence, rose oil, vanilla, lemon oil, orange oil, orange blossom, cherry blossom, Cassia, caraway, cognac, jasmine, ylang-ylang, sage, fennel, wasabi, piment, ginger, coriander, coffee, hemp, a mint oil from any species of the genus Mentha, Eucalyptus, star anise, cocoa, lemongrass, rooibos, flax, Ginkgo biloba, hazel, hibiscus, laurel, mate, orange skin, rose, tea such as green tea or black tea, thyme, juniper, elderflower, basil, bay leaves, cumin, oregano, paprika, rosemary, saffron, lemon peel, mint, beefsteak plant, Curcuma, cilantro, myrtle, cassis, valerian, pimento, mace, damien, marjoram, olive, lemon balm, lemon basil, chive, Carvi, Verbena, tarragon, limonene, thymol, camphene), flavor enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, liquid such as an oil, solid such as a powder, or gas.

In some embodiments, the flavor comprises menthol, spearmint and/or peppermint. In some embodiments, the flavor comprises flavor components of cucumber, blueberry, citrus fruits and/or redberry. In some embodiments, the flavor comprises eugenol. In some embodiments, the flavor comprises flavor components extracted from tobacco. In some embodiments, the flavor comprises flavor components extracted from Cannabis.

In some embodiments, the flavor may comprise a sensate, which is intended to achieve a somatosensorial sensation which are usually chemically induced and perceived by the stimulation of the fifth cranial nerve (trigeminal nerve), in addition to or in place of aroma or taste nerves, and these may include agents providing heating, cooling, tingling, numbing effect. A suitable heat effect agent may be, but is not limited to, vanillyl ethyl ether and a suitable cooling agent may be, but not limited to eucolyptol, WS-3.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features structures, and/or other aspects described herein are not to be considered limitations on the scope of the claims or limitations on equivalents to the claims and that other embodiments may be utilized and modifications may be made without departing from the scope of the claims. Various embodiments of the disclosure may suitably comprise, consist of or consist essentially of, appropriate combinations of the disclosed elements, components, features parts, steps, means, etc., other than those specifically described herein. In addition this disclosure may include other inventions not presently claimed, but which may be claimed in future.

1. An article for use with a non-combustible aerosol provision device, the article comprising:
a continuous rod of aerosol-generating material; and
a coil disposed around the rod of aerosol-generating material, wherein the coil comprises heating material that is heatable by penetration with a varying magnetic field.

2. The article according to claim 1, further comprising an elongate member disposed within the rod of aerosol-generating material, wherein the elongate member comprises thermally conductive material.

3. The article according to claim 2, wherein the article has a longitudinal axis, and the elongate member extends along, or substantially parallel to, the longitudinal axis of the article.

4. The article according to claim 2, wherein the elongate member is substantially cylindrical or substantially planar.

5. The article according to claim 2, further comprising a catalytic material on at least a portion of the elongate member.

6. The article according to claim 2, wherein the elongate member comprises heating material that is heatable by penetration with a varying magnetic field.

7. The article according to claim 6, further comprising a connecting member connecting a first end of the coil with a first end of the elongate member, wherein the connecting member comprises heating material that is heatable by penetration with a varying magnetic field.

8. The article according to claim 7, wherein the coil, the elongate member, and the connecting member are integrally formed.

9. The article according to claim 1, wherein the coil is helical in shape.

10. The article according to claim 1, wherein at least one of:
the coil extends only partially along the rod of aerosol-generating material, or
the coil extends between 20% and 90% of a length of the aerosol-generating material.

11. The article according to claim 1, wherein the coil consists entirely, or substantially entirely, of the heating material.

12. The article according to claim 1, further comprising a wrapper surrounding the rod of aerosol-generating material, wherein the coil is disposed around the wrapper.

13. The article according to claim 12, wherein the wrapper comprises at least one of paper or a metal layer.

14. An article for use with a non-combustible aerosol provision device, the article comprising:
aerosol-generating material;
a wrapper surrounding the aerosol-generating material; and
a coil comprising heating material that is heatable by penetration with a varying magnetic field, wherein the coil is disposed around the wrapper.

15. An article for use with a non-combustible aerosol-provision device, the article comprising:
a rolled sheet having a spiral cross-section, the rolled sheet comprising:
aerosol-generating material, and
a mesh comprising heating material that is heatable by penetration with a varying magnetic field.

16. The article according to claim 15, wherein the mesh is in contact with the aerosol-generating material.

17. The article according to claim 15, wherein the rolled sheet comprises a sheet comprising the aerosol-generating material.

18. The article according to claim 17, wherein the mesh is on a surface of the sheet comprising the aerosol-generating material.

19. The article according to claim 15, further comprising an adhesive disposed between overlapping portions of the rolled sheet.

20. The article according to claim 15, further comprising a mass of aerosol-generating material, wherein the mass of aerosol-generating material is encircled by the rolled sheet.

21. The article according to claim 20, wherein the article has a longitudinal axis, and the mass of aerosol-generating material extends along the longitudinal axis of the article.

22. The article according to claim 15, wherein the mesh consists entirely, or substantially entirely, of the heating material.

23. The article according to claim 15, further comprising a wrapper surrounding the rolled sheet.

24. The article according to claim 23, wherein the wrapper comprises at least one of paper or a metal layer.

25. An article for use with a non-combustible aerosol-provision device, the article comprising:
a continuous rod of aerosol-generating material, the rod having a longitudinal axis; and
one or more bodies disposed in an axial region of the rod of aerosol-generating material, the axial region extending along the longitudinal axis of the rod,
wherein the one or more bodies have a circular cross-section and a diameter in a range of 0.5 mm to 5 mm, and wherein the one or more bodies comprise heating material that is heatable by penetration with a varying magnetic field.

26. The article according to claim 25, comprising a plurality of the bodies.

27. The article according to claim 26, wherein the bodies are spaced evenly, or substantially evenly, along the longitudinal axis of the rod.

28. The article according to claim 26, wherein the spacing between consecutive bodies is between about 2 mm and about 10 mm.

29. The article according to claim 25, wherein the one or more bodies are substantially spherical or substantially cylindrical.

30. The article according to claim 25, wherein the one or more bodies consist entirely, or substantially entirely, of the heating material.

31. The article according to claim 25, further comprising a catalytic material on at least a portion of the one or more bodies.

32. The article according to claim 25, further comprising a wrapper surrounding the rod of aerosol-generating material.

33. The article according to claim 32, wherein the wrapper comprises at least one of paper or a metal layer.

34. The article according to claim 25, wherein at least one of:
the one or more bodies are hollow and have a wall thickness between about 0.5 mm and about 3 mm; or
the one or more bodies are formed from at least one of a porous material or a permeable material.

35. The article according to claim 1, wherein the heating material comprises at least one of an electrically-conductive material or a magnetic material.

36. The article according to claim 1, wherein the heating material comprises a metal or a metal alloy.

37. The article according to claim 36, wherein the heating material comprises stainless steel or aluminum.

38. The article according to claim 1, wherein the aerosol-generating material is reconstituted, cellulosic, or in gel form.

39. The article according to claim 1, wherein the aerosol-generating material comprises tobacco material.

40. The article according to claim 1, wherein the article is substantially cylindrical.

41. A non-combustible aerosol delivery system comprising:
a non-combustible aerosol provision device; and
the article according to claim 1.

42. A method of manufacturing an article for use with a non-combustible aerosol provision device, the method comprising:
transferring aerosol-generating material along a transfer path;
inserting one or more bodies into an axial region of the aerosol-generating material, wherein the one or more bodies have a circular cross-section and a diameter in a range of 0.5 mm to 5 mm, and wherein the one or more bodies comprise heating material that is heatable by penetration with a varying magnetic field; and
forming the aerosol-generating material into a continuous rod of the aerosol-generating material.

43. The method according to claim 40, wherein the one or more bodies comprise a plurality of bodies, and inserting the bodies into the axial region of the aerosol-generating material is performed such that consecutive bodies are spaced by at least about 2 mm, at least about 3 mm, or at least about 4 mm.

44. The method according to claim 42, further comprising cutting the continuous rod of aerosol-generating material to provide a plurality of rod segments, and forming each rod segment into one or more aerosol-generating sections or one or more respective articles, each aerosol-generating section having an upstream end and a downstream end in the respective article, and a body of heating material disposed in the aerosol-generating section closer to the downstream end than the upstream end of the aerosol-generating section.

45. A body of aerosol-generating material for use with a non-combustible aerosol-provision device, the body comprising:
one or more filaments extending though a full length of the body, the one or more filaments formed of heating material that is heatable by penetration with a varying magnetic field.

46. The body according to claim 45, further comprising a plurality of the filaments.

47. The body according to claim 45, wherein the one or more filaments comprise at least one material selected from the group consisting of: gold, iron, nickel, cobalt, copper, conductive carbon, graphite, bronze, plain-carbon steel, stainless steel, ferritic stainless steel, and grade 430 stainless steel.

48. The body according to claim 45, wherein each filament comprises a resistance wire, a multi-strand wire, or a ribbon.

49. A method of manufacturing an article for use with a non-combustible aerosol provision device, the method comprising:
transferring aerosol-generating material along a transfer path;
feeding one or more filaments into the aerosol-generating material, wherein the one or more filaments comprise heating material that is heatable by penetration with a varying magnetic field; and
forming the aerosol-generating material into a continuous rod of the aerosol-generating material.

50. A method of manufacturing an article for use with a non-combustible aerosol provision device, the method comprising:
providing a continuous rod of aerosol-generating material;
providing an elongate member, wherein the elongate member comprises heating material that is heatable by penetration with a varying magnetic field; and
inserting the elongate member into a longitudinal end of the rod of the aerosol-generating material.

51. The method according to claim 46, wherein the elongate member is inserted such that a longitudinal end surface of the elongate member is exposed.
